(19) United States
(12) Patent Application Publication
(10) Pub. No.: US 2020/0034750 A1
(43) Pub. Date: Jan. 30, 2020

(54) GENERATING ARTIFICIAL TRAINING DATA FOR MACHINE-LEARNING

(71) Applicant: SAP SE, Walldorf (DE)

(72) Inventors: Marcus Ritter, Waldbrunn (DE); Owen Hickey-Moriarty, Wiesloch (DE); Baris Yalcin, Walldorf (DE)

(73) Assignee: SAP SE, Walldorf (DE)

(21) Appl. No.: 16/046,863

(22) Filed: Jul. 26, 2018

(51) Int. Cl. G06N 99/00

(52) U.S. Cl. CPC G06N 99/005

(57) ABSTRACT

A system and process for artificially generating training data for machine-learning is provided herein. One or more input vectors for a machine-learning system may be identified. One or more parameters for the training data based on a domain of the machine-learning system may be retrieved. One or more functions for generating the training data corresponding to the one or more input vectors may be retrieved. One or more data sources may be accessed to retrieve one or more sets of data for building a data foundation for generating the training data. Training data corresponding to the one or more input vectors may be generated based on the one or more parameters and the one or more data foundations. The machine-learning system may be trained via the generated training data obtained from the database.

### FIELD

The present disclosure generally relates to training machine-learning systems and processes. Particular implementations relate to using artificially constructed data for training machine-learning algorithms, including pre-generation and real-time generation of the artificial training data.

### BACKGROUND

Machine-learning processes or algorithms may provide effective solutions to a variety of computational problems. Such machine-learning solutions generally require training, which may require large amounts of data to effectively complete the training. However, such data is not always available. Thus, there is room for improvement.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A system and process for machine-learning using artificially generated training data is provided herein. One or more input vectors for a machine-learning system may be identified. A database for storing training data may be determined. One or more parameters for the training data based on a domain of the machine-learning system may be retrieved. One or more functions for generating the training data corresponding to the one or more input vectors may be retrieved. One or more data sources may be accessed to retrieve one or more sets of data for building a data foundation for generating the training data. Training data corresponding to the one or more input vectors may be generated based on the one or more parameters and the one or more data foundations. Generating the training data may include executing a function associated with a given input vector to generate one or more values for the given input vector based on one or more associated parameters for the given input vector. The generated training data may be stored in the database. The machine-learning system may be trained via the generated training data obtained from the database.

A system and process for generating artificial training data is provided herein. An input vector definition for a target machine-learning system may be received. One or more parameters for generating values for the input vector may be determined. A statistical model for generating values for the input vector may be determined. A training value for the input vector may be generated by executing the statistical model using the one or more parameters. The training value may be stored in a training data database. The target machine-learning system may be trained via the generated training value obtained from the training data database.

A system and process for training a machine-learning system using artificial training data is provided herein. A set of input vectors for the machine-learning system may be detected. One or more parameters for respective vectors of the set of input vectors for generating values for the respective vectors may be retrieved. One or more methods of generating values associated with the respective input vector may be identified. A set of values for the set of input vectors may be generated. Generating the one or more values may include executing the method based on the one or more parameters to generate training data values for the given input vector. The machine-learning system may be trained via the set of values.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic diagram depicting an architecture of a training data generator system.

FIG. 2A is a flowchart illustrating a process for pre-generating training data.

FIG. 2B is a flowchart illustrating a detailed process for pre-generating training data.

FIG. 2C is a flowchart illustrating a split process for pre-generating training data.

FIG. 2D depicts example tables of a domain and data foundation for generating artificial training data.

FIG. 3 is a schematic diagram depicting an architecture for an on-the-fly training data generator system.

FIG. 4A is a flowchart illustrating a process for generating training data on-the-fly.

FIG. 4B is a flowchart illustrating a parallelized process for generating training data on-the-fly.

FIG. 5A is a schematic diagram depicting an application environment for a training data generator.

FIG. 5B is a schematic diagram depicting a system environment for a training data generator.

FIG. 5C is a schematic diagram depicting a network environment for a training data generator.

FIG. 6A-1 depicts an example set of input and output vectors for training data to train a machine-learning system.

FIG. 6A-2 depicts an example set of generated input and output vectors of training data to train a machine-learning system.

FIG. 6B depicts an example entity-relationship diagram for a database for storing generated artificial training data.

FIG. 6C depicts example code for setting parameters for generating training data.

FIG. 6D depicts example code for a training data generator, and a call to the training data generator.

FIG. 6E depicts example code for defining a training data generator class.

FIG. 6F depicts example code for defining a process or method for generating the training data.

FIG. 6G depicts example code for implementing and executing a training data generator.

FIG. 7A is a flowchart illustrating a process for machine-learning using artificially generated training data.

FIG. 7B is a flowchart illustrating a process for generating artificial training data.

FIG. 7C is a flowchart illustrating a process for training a machine-learning system using artificial training data.

FIG. 8 is a diagram of an example computing system in which described embodiments can be implemented.

FIG. 9 is an example cloud computing environment that can be used in conjunction with the technologies described herein.

### DETAILED DESCRIPTION

A variety of examples are provided herein to illustrate the disclosed technologies. The technologies from any example can be combined with the technologies described in any one or more of the other examples to achieve the scope and spirit of the disclosed technologies as embodied in the claims, beyond the explicit descriptions provided herein. Further, the components described within the examples herein may be combined or recombined as well, as understood by one skilled in the art, to achieve the scope and spirit of the claims.

### EXAMPLE 1

### Artificial Training Data Generator Overview

Generally, developing a reliable and effective machine-learning process requires training the machine-learning algorithm, which generally requires training data appropriate for the problem being solved by the trained algorithm. Often, a massive amount of data is needed to effectively train a machine-learning algorithm. Generally, real-world or “production” data is used in training. However, production data is not always available, or not available in sufficiently large amounts. In such cases, it may take significant time before a machine-learning component can be independently used. That is, a process can be manually implemented, and the results used as training data. Once enough training data has been acquired, the machine-learning component can be used instead of manual processing. Or, a machine-learning component can be used that has been trained with less than a desired amount of data, and the results may simply be suboptimal until the machine-learning component undergoes further training.

In some cases, even if it is available, production data cannot be safely used, or at least without further processing. For instance, production data may include personally identifying information for an individual, or other information protected by law, or trade secrets or otherwise which should not be shared. In some cases, legal agreements, or the lack of a contractual or other legal agreement, may prohibit the use or transfer of production data (or even previously provided development testing data). Data masking or other techniques may not always be sufficient or cost-effective to make production data useable for machine-learning training. Even if data is available, and can be made useable for training, significant effort may be required to restructure or reformat the data to make it useable for training.

In some cases, such as for outcome-based machine-learning training (e.g. reinforcement learning), production data may be available as input to the algorithm, but no determined outcome is available for training the algorithm. This type of production data may have output saved for the given inputs, but no indication (or labelling) if the output is desirable or not (effective or otherwise correct). Such data that lacks the inclusion of labelled outputs is generally not useful for training machine-learning algorithms that target particular outputs or results, but may be useful for algorithms that identify information or traits of the input data. In some cases, it is not possible to determine the output results for given inputs, or to determine if the output results are desirable (or otherwise apply a labelling, categorization, or classification). In other cases, doing so would be far more difficult or time- or resource-consuming than generating new training data.

Generating artificial training data according to the present disclosure may remedy or avoid any or all of these problems. As used herein, “artificial training data” refers to data that is in whole or part created for training purposes and is not entirely, directly based on normal operation of processing which is to be analyzed using a trained machine-learning component. In at least some cases, artificial training data does not directly include any information from such normal processing. As will be described, artificial training data can be generated using the same types of data, including constraints on such data, which can be based on such normal processing. For example, if normal processing results in possible data values between 0 and 10, artificial training data can be similarly constrained to have values between 0 and 10. In other cases, artificial training data need not be constrained, or need not have the same constrains as data that would be produced using normal processing which will later be analyzed using the trained machine-learning component.

In many cases, the architecture and programs used to generate training data can also be re-used for training other machine-learning algorithms that are related to, but different from, the initial target algorithm, which may further save costs and increase efficiency, both in time to train an algorithm and by increasing effectiveness of the training. Further, generated training data may be pre-generated training data that can be accessed for use in training at a later date, or may be generated in real-time, or on-the-fly, during training. Generated training data may be realistic, such as when pre-generated, or it may minimally match the necessary inputs of the machine-learning algorithm but otherwise not be realistic, or have a varying level of realism (e.g. quality). Generally, a high-level of realism is not necessary in the generated training data for the training data to effectively and efficiently train a machine-learning algorithm.

Surprisingly, it has been found that, at least in some cases, artificial training data can be more effective at training a machine-learning component than using “real” training data. In some implementations, such effectiveness can result from training data that does not include patterns that exactly replicate real training data, and may include data that is not constrained in the same way as data produced in normal operation of a system to be analyzed using the machine-learning component. Thus, disclosed technologies can provide improvements in computer technology, including (1) better data privacy and security by using artificial data instead of data that be may associated with individuals; (2) data that can be generated with less processing, such as processing that would be required to anonymize or mask data; (3) improved machine-learning accuracy by providing more extensive training data; (4) having a machine-learning component be available in a shorter time frame; and (5) improved machine-learning accuracy by using non-realistic, artificial training data.

### EXAMPLE 2

### Machine-Learning and Training Data

Machine-learning algorithms or systems (e.g. artificial intelligence) as described herein may be any machine-learning algorithm that can be trained to provide improved results or results targeted to a particular purpose or outcome. Types of machine-learning include supervised learning, unsupervised learning, neural networks, classification, regression, clustering, dimensionality reduction, reinforcement learning, and Bayesian networks.

Training data, as described herein, refers to the input data used to train a machine-learning algorithm so that the machine-learning algorithm can be used to analyze “unknown” data, such as data generated or obtained in a production environment. The inputs for a single execution of the algorithm (e.g. a single value for each input) may be a training data set. Generally, training a machine-learning algorithm includes multiple training data sets, usually run in succession through the algorithm. For some types of machine-learning, such as reinforcement learning, a desired or expected output is also part of the training data set. The expected output may be compared with output from the algorithm when the training data inputs are used, and the algorithm may be updated based on the difference between the expected and actual outputs. Generally, each processing of a set of training data through the machine-learning algorithm is known as an episode or cycle.

### EXAMPLE 3

### Training Data Generator System Architecture

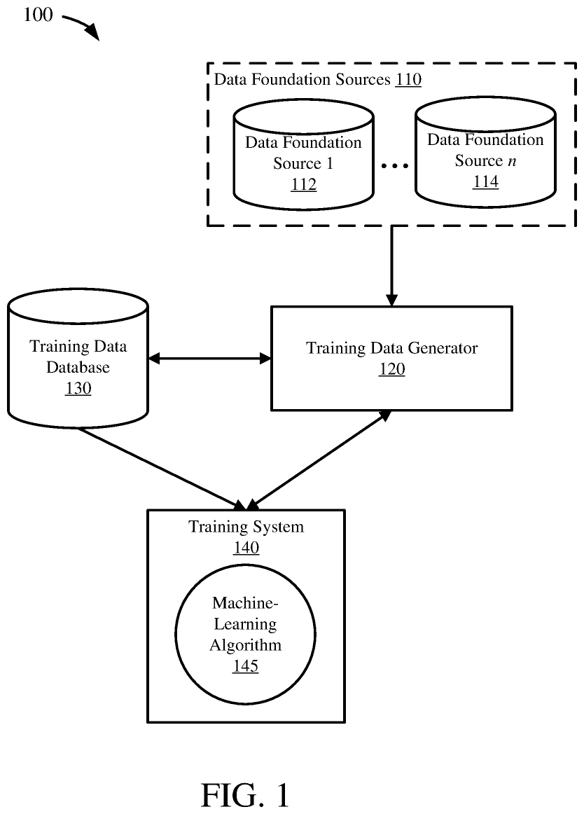

FIG. 1 is a schematic diagram depicting an architecture 100 of a training data generator system. A training data generator 120 may generate artificial training data for training a machine-learning algorithm 145, as described herein. The training data generator 120 may access a training data database 130. The training data generator 120 may retrieve data from, or store data in, the training data database 130. The training data generator 120 may also access a training system 140. In some embodiments, the training data generator 120 and the training system 140 may be fully or partially integrated together. In some embodiments, the training data generator 120 may be composed of several programs, designed to interact or otherwise be compatible with each other, or be composed of several microservices similarly integrated.

The training data database 130 may be a database or database management system housing training data for training a machine-learning algorithm. Generally, the database 130 may store multiple sets of training data for training a given machine-learning algorithm. In some embodiments, the database 130 may store many different groups of training data, each group for training a separate or different machine-learning algorithm for a separate or different purpose (or on a different group of data); each group generally will have multiple sets of data.

One or more training systems 140 may access the training data database 130, such as to retrieve training data for use in training the machine-learning algorithm 145. In some embodiments, the database 130 may be a file storing the training data, such as in a value-delimited format, which may be provided to the training system 140 directly (e.g. the file name provided as input to the training system, then read into memory for the training system, or otherwise accessed programmatically). In other embodiments, the training data database 130 may be a database system available on a network, such as through a developed database interface, stored procedures, or direct queries, which can be received from the training system 140.

The training system 140 may train the machine-learning algorithm 145 using training data as described herein. Training data, as used through the remainder of the present disclosure should be understood to refer to training data that includes at least some proportion of artificial training data. In some scenarios, all of the training data can be artificial training data. In other scenarios, some of the training data can be artificial training data and other training data can be real training data. Or, data for a particular training data set can include both artificial and real values.

Generally, the training system 140 obtains training data from either the training data database 130, from the training data generator 120, or a combination of both. The training system 140 feeds the training data to the machine-learning algorithm 145 by providing the training inputs to the algorithm and executing the algorithm. In some cases, the output from the algorithm 145 is compared against the expected or desired output for the given training data set, as obtained from the training data, and the algorithm is then updated based on the differences between the current output and expected output.

The training data generator 120 may access one or more data foundation sources 110, such as data foundation source 1 112 through data foundation source n 114. The training data generator 120 may use data obtained from the data foundation sources 110 to generate one or more fields or input vectors of the generated training data.

For example, an address field may be an input vector for a machine-learning algorithm. The training data generator 120 may access an available post office database, which may be data foundation source 1 112, to obtain valid addresses for use as the address input vector during training. Another input vector field may be a resource available for use or sale, such as maintained in an internal database of all available computing resources, which may be another data foundation source 110. Such internal database may be accessed by the training data generator 120 for obtaining valid resources available as input to the machine-learning algorithm.

In other scenarios, the training data generator 120 may access one or more data foundation sources 110 to determine parameters for generating the training data. For example, the training data generator may access a census database to determine the population distribution across various states. This population distribution data may be used to generate a similar distribution of addresses for an address input vector. Thus, the data foundation sources 110 may be used to increase the realism of the training data, or otherwise provide statistical measures for generating training data. However, as described above, in some scenarios, it may be desirable to decrease the realism of the training data, as that can result in a trained machine-learning component that provides improved results compared to a machine-learning component trained with real data (or, at least, when the same amounts of training data are used for both cases).

Data foundation sources 110 may be external data sources, or may be internal data sources that are immediately available to the training data generator 120 (e.g. on the same network or behind the same firewall). Example data foundation sources are Hybris Commerce™, SAP for Retail, SAP CAR™, or SAP CARAB™, all from SAP, SE (Walldorf, Germany), specific to an example for a machine-learning order sourcing system. Other examples may be U.S. Census Bureau reports or the MAXMIND™ Free World Cities Database. Further examples may include internal databases such as warehouse inventories or locations, or registers or computer resources, availability, or usage.

Once trained, the machine-learning algorithm 145 may be used to analyze production data, or real-world inputs, and provide the substantive or production results for use by a user or other computer system. Generally, the quality of these production results may depend on the effectiveness of the training process, which may include the quality of the training data used. In this way, the generated artificial training data may improve the quality of the production results the machine-learning algorithm 145 provides in production by improving the training of the machine-learning algorithm.

### EXAMPLE 4

### Pre-Generating Training Data

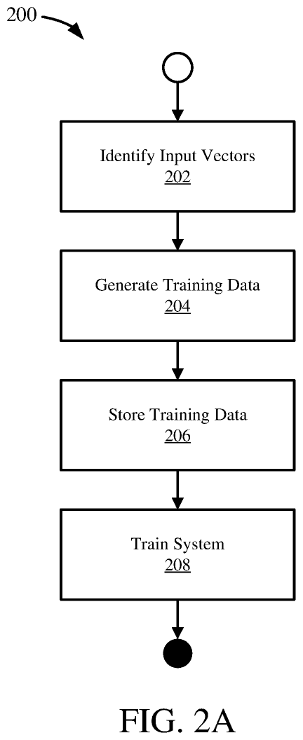

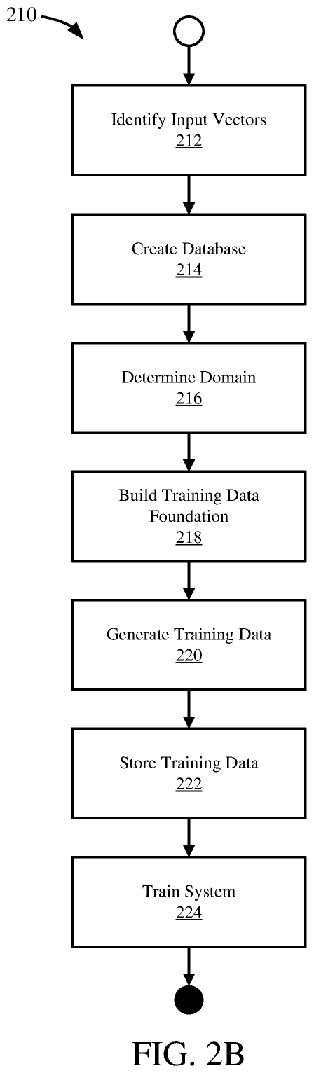

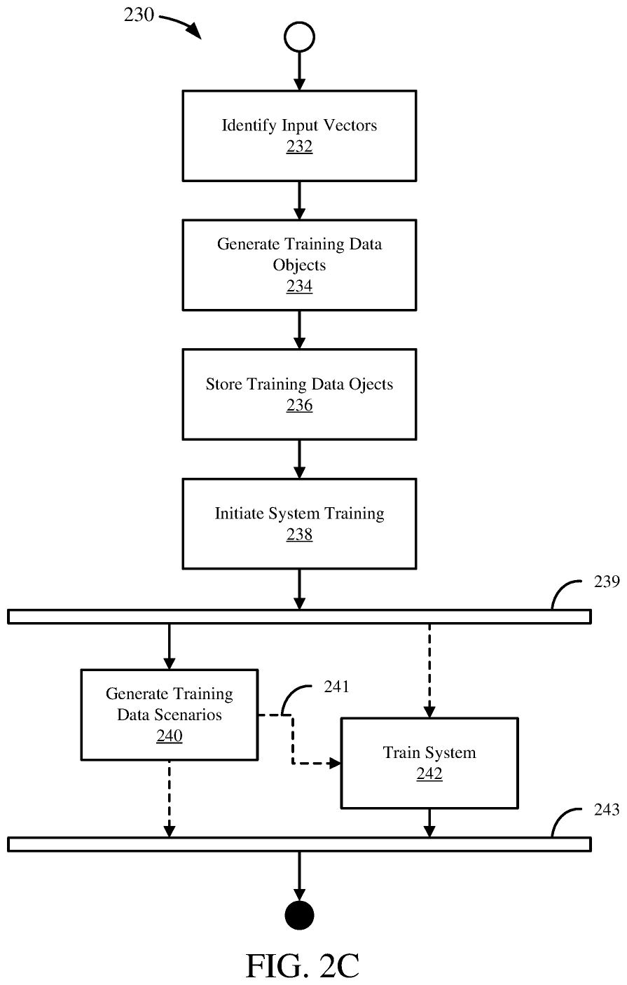

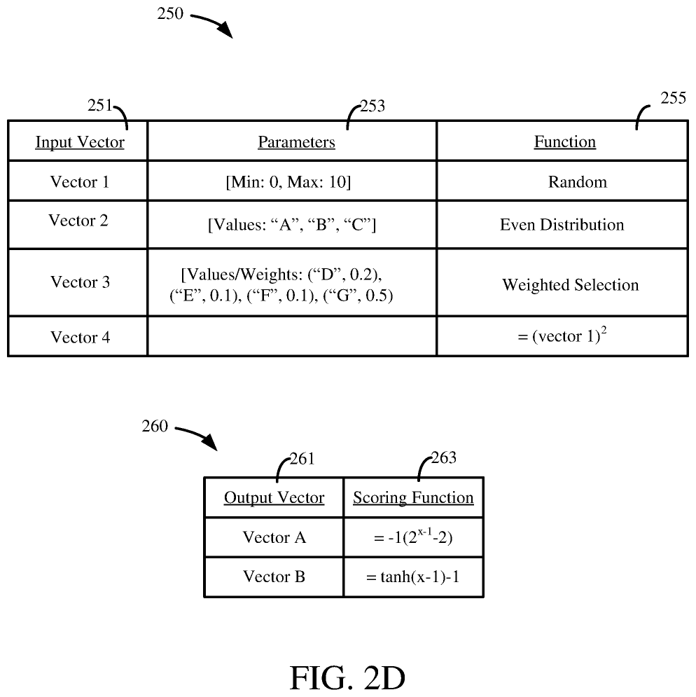

FIG. 2A is a flowchart illustrating a process 200 for pre-generating training data. Input vectors are identified at 202. Generally, the input vectors are the input variables of the machine-learning algorithm which the training, using the generated artificial training data, is intended to train. An input vector may be a simple variable or a complex variable, or an input vector may include one or more simple variables, one or more complex variables, or a combination thereof, including within a vector format or within another data structure or data collection (e.g., an instance of an abstract or complex data type, a collection of objects, such as an array, or a data structure, such as a tree, heap, queue, list, stack, etc.). The simple variables typically have one or more of a single value or a primitive data type (e.g., float, int, character array). Complex variables typically have multiple values and/or composite or abstract data types. Either simple variables or complex variables can be associated with a data structure. In some scenarios, the input vectors may be interrelated, or otherwise have relationships with one or more other input vectors. Generally, the input vectors may be the definitions of the data that will be generated as the training data. The input vectors may define, directly or indirectly, the generated training data.

For example, an input vector may be a simple integer-type variable (type INT). Thus, one field of the training data may correspond to this input vector, and similarly be an integer-type variable. As another example, an input vector may be a complex data structure (or a composite or abstract data type) with three simple variables of types STRING, INT, and LONGINT. Thus, one field of the training data may correspond to this input vector and similarly be a complex data structure with the specified three simple variables. Alternatively, the training data may have three simple variables corresponding to those in the complex data structure input variable, but not have the actual data structure.

Identifying input vectors may include analyzing the object code or source code of the target machine-learning system (e.g. the machine-learning algorithm to be trained) to determine or identify the input arguments to the target system. Thus, identifying the input vectors at 202 may include receiving one or more files containing the object code or source code for the target system, or receiving a file location or namespace for the target system, and accessing the files at the location or namespace. Data from a file, or other data source, can be analyzed to determine what input vectors or arguments are used by the target system, which can in turn be used to define the input vector or arguments for which artificial training data will be created. In this way, disclosed technologies can support automatic creating of artificial training data for an arbitrary machine-learning system or use case scenario.

Additionally or alternatively, identifying the input vectors may include determining or retrieving the input vectors from a data model for the target machine-learning system. This determining or retrieving may include accessing one or more files or data structures (e.g. a database) with the data model information for the target system and reading the input vector or input argument data. In some embodiments, the input vectors may be provided through a user interface, which may allow a user to provide one or more input vectors with an associated type, structure, length, or other attributes necessary to define the input vectors and generate data that matches the input vector. In other embodiments, the input vector definitions may be provided in a file, such as a registry file or delimited value file, and thus identifying the input vectors may include reading or accessing this file.

Training data may be generated at 204. Generating training data may include generating one or more sets of data, where each set of data has a value for each input vector identified at 202. In some scenarios, each set of data may have sufficient values to provide a value for the identified input vectors, but the values in the set of training data may not correspond one-for-one to the input vectors. For example, some training data may be generated that allows an input vector to be calculated at the time of use, such as generating a date-of-birth field for the training data and calculating an age based on the date-of-birth training data for the input vector.

The training data may be generated at 204 using various parameters, definitions, or restrictions, on the values of the input vectors, or may be generated based on statistical models or distributions for the values of the input vectors, either individually or in groups. Generating training data at 204 generally includes generating training data objects and training data scenarios, as described in process 230 shown in FIG. 2C.

Generally, a fixed number of data sets of the generated training data are generated at a given time. An input number may be provided that determines the number of training data sets to be generated. For example, 100,000 data sets of training data may be requested, and so training data for the identified input vectors may be generated for 100,000 sets (or 100,000 times); if there are, for example, 10 input vectors, then values for the 10 input vectors will be generated 100,000 times. Generally, values for the training data may be generated by set, rather than by input vector. However, in some embodiments, the training data may be generated by variable (or input vector) rather than by set.

Each set of generated training data may be generated randomly or semi-randomly, within any constraints of the parameters, domain, data foundation, and so on. Generally, such randomized sets of training data are sufficient to train a machine-learning algorithm for a given task. In some cases, more exotic data samples may be useful to expand the range of possible inputs that the machine-learning algorithm can effectively process once trained. A Poisson distribution (a discrete probability distribution) may be used in generating training data. The Poisson distribution generally expresses the probability of a given number of values occurring in a fixed interval. Thus, the distribution of values generated can be controlled by using a Poisson distribution and setting the number of times a given value is expected to be generated over a given number of iterations (where the number of iterations may be the number of sets of training data to be generated).

Further, generating the training data may also include generating expected results or output data for the generated set of input data. Expected output data may be part of its respective set of training data. For a set of data, the output data may be one or more fields, depending on the desired results from the machine-learning algorithm. In some embodiments, generating the training data may be accomplished by first generating output results for a given set, and then generating the input variables based on the generated output results (e.g. reverse engineering the inputs).

The generated training data is stored at 206. The training data may be stored in a database, such as the training data database 130 shown in FIG. 1. The training data may alternatively or additionally be stored in a file or other data storage system. In some embodiments, the training data is stored after all the training data has been generated. In other embodiments, the training data is stored as it is generated; generally, this will consume less local memory during generation of the training data. For example, once a set of training data is generated, it may be stored before or while the next set of training data is generated.

The machine-learning algorithm or system is trained at 208. Training the machine-learning algorithm may include accessing the training data stored at 206 and feeding it into the machine-learning algorithm. This may be accomplished by the training system 140 as shown in FIG. 1. Generally, training the algorithm includes providing a single set of training data inputs to the machine-learning algorithm, running the algorithm with the generated training data inputs, obtaining the results of the algorithm from processing the inputs, comparing the results to expected results (e.g. the generated expected results for the given training data set), and updating the algorithm based on the differences between the output and the expected results. This process may be repeated for all available generated training data sets as part of training the machine-learning algorithm. Training may continue until the differences between the output from the algorithm and the expected results are below a certain threshold, below a threshold for a given number of training cycles, or for a given number of training cycles or episodes.

FIG. 2B is a flowchart illustrating a detailed process 210 for pre-generating training data. Input vectors are identified at 212. Identifying input vectors at 212 may be similar to step 202 as shown in FIG. 2A. The input vectors may be the input variables of the machine-learning algorithm, as described herein.

A database for storing the generated training data is created or accessed at 214. The database may serve as a central storage unit for all generated training data and data sets, and further may provide a simplified interface or access to the generated training data. Such a database may be the training data database 130 shown in FIG. 1. The database may allow generated training data to be re-used in the future, further refined to improve training results, or altered or adapted for training different algorithms or training to a different purpose or goal.

Creating the database at 214 (or a altering a previously created database) may include defining multiple fields, multiple tables, or other database objects, and defining interrelationships between the tables, fields, or the other database objects. Creating the database at 214 may further include developing an interface for the database, such as through stored procedures. Generally, creating the database at 214 includes using the identified input vectors from step 212 to determine or define the requisite database objects and relationships between the objects, which may correlate to the input vectors in whole or in part. For example, a given input vector may have a table created for storing generated training data for that input vector. As another example, a given input vector may be decomposed into multiple tables for storing the generated training data for the given input vector. In a yet further example, a table can have records, where each record represents a set of training data, and each field defines or identifies one or more values for one or more input vectors that are included in the set.

Using a database as described herein may allow the generation of training data to be accomplished at different times based on the different data fields generated. For example, training data for a given input vector may be generated at one time and stored in a given table in a database created at 214 for the training data. Later, training data for a different input vector may be generated and stored in another table in the database. In this way, pre-generating training data may be further divided or segmented to allow more flexibility or more efficient use of computing resources (e.g. scheduling training data generation during low-use times on network servers, or generating training data for new input vectors without regenerating training data for input vectors previously generated). Such segmentation of training data generation may be further accomplished according to process 230 shown in FIG. 2C. Thus, creating a training data database may provide increased flexibility and efficiency in generating training data.

The domain or environment for the generated training data is determined at 216. Determining a domain or environment may include defining parameters for the input vectors being generated as the training data. The parameters can define the domain with respect to a particular task to which the trained machine-learning algorithm will be put, and then further translating that definition to the specific input vectors and training data. That is, even for the same input vectors, the parameters for the input vectors can vary depending on specific use cases. Determining a domain or environment may additionally or alternatively include defining one or more functions for evaluating or scoring results generated by the training data when processed through the target machine-learning system, or determining parameters for generating expected outcome results in addition to generating the input training data.

Generally, defining the domain or environment should result in a restricted, or well-defined environment for the training data, which ultimately leads to a well-trained or adapted machine-learning algorithm for the particular task to which it is put. The environment may include defining values or ranges for the various input vectors of the training data, or weights for the various input vectors, or a hierarchy of the input vectors. Defining the environment may also include adding or removing particular input vectors, or incorporating several input vectors together (such as through a representational model). Data defining the domain may be stored in local variables or data structures, a file, or the database created at 214, or may be used to modify or limit the database.

By defining the domain for the generated training data, the training data will more effectively train a machine-learning algorithm for a given task, rather than training the machine-learning algorithm for a generic solution. In many scenarios, a machine-learning algorithm trained for a specific task or domain may be preferable to a generic machine-learning solution, because it will provide better output results than a generic solution, which may be trying to balance or select between countervailing interests. Defining the domain of the generated training data focuses the generated training data so that it in fact trains a machine-learning algorithm to the particular domain or task, rather than any broad collection of input vectors.

For example, a machine-learning algorithm may be trained to provide product sourcing for a retail order. However, the expectations for fulfilling a retail order may be very different for different retail industries. In the fashion industry, for example, orders may generally have an average of five items, and it generally does not matter which items are ordered, only whether the items are in stock or not. However, in the grocery industry, orders may contain 100+ items, and different items may need to be shipped or packaged differently, such as fresh produce, frozen items, or boxed/canned items. Thus, the domain for a machine-learning order-sourcing algorithm for a fashion retailer may focus on cost to ship and customer satisfaction, whereas an order-sourcing algorithm for a grocer may focus on minimizing delivery splits, organizing packaging, or ensuring delivery within a particular time.

As another example, a machine-learning algorithm may be trained to provide resource provisioning for computer resource allocation requests. Again, the expectations for fulfilling resource provisioning requests may vary for different industries or different computing arenas. In network routing, for example, network latency may be a key priority in determining which resources to provision for analyzing and routing data packets. However, in batch processing, network latency may not be a consideration or may be a minimal consideration. Memory quantity or core availability may be more important factors in provisioning computing resources for batch processing. Thus, the domain for network resource provisioning may focus on availability (up-time) and latency, whereas the domain for batch processing may focus on computing power and cache memory available.

A training data foundation may be built or structured at 218. The training data foundation may be a knowledge base or statistical foundation for the training data to be generated. This data foundation may be used to ensure that the generated training data is realistic training data, and so avoid noise, or sufficiently unrealistic training data that the data inaccurately trains a machine-learning algorithm when used. However, as described above, in some cases it has been found, surprisingly, that unrealistic training data may actually be more effective for training than realistic data. Or, the degree of realism may not matter or have much impact, which can simplify the process of generating artificial training data, as fewer “rules” for generating the data need be considered or defined. In some cases, a training data foundation may make the generation of training data simpler or less time or resource intensive.

The data foundation may be built from varying sources of data, such as the data foundation sources 110 shown in FIG. 1. The training data foundation may be sets of data which may be used to generate the training data, or may be statistical models or distributions of data which may be used in generating the training data. In some scenarios, the statistical models or distributions of data may be derived from one or more data sets being used to build the training data foundation. The degree of realism of the training data may be adjusted based on the use of data foundation sources and the degree or extent to which the training data foundation is built. In some embodiments, the training data foundation may be constructed, or modified, based on the domain determined at 216. That is, the domain may allow values to be removed from the training data foundation, or used in filtering values retrieved from the training data foundation. In some embodiments, the data foundation may define, at least in part, the parameters for the generated training data, such as from the domain determined at 216.

For example, continuing the resource provisioning example, training data may be generated for resource addresses, for which an IP address may be sufficient address information. A list of IP addresses may be obtained from a data source, such as a registry of local or accessible network locations. This list may be part of the data foundation for generating the training data. For cases generating less realistic training data, the selection of addresses, for generated jobs, from the data foundation list may be random, or evenly distributed, or so on. For cases generating more realistic data, usage distribution data may be obtained for each address, and the addresses selected for jobs based on their percentage of the overall usage, such that more used addresses have more jobs and less used addresses have fewer jobs.

The data foundation may be set, at least in part, through a user interface. Such a user interface may allow data sources to be selected or input (e.g. web address), or associated with one or more input vectors or parameters.

Training data may be generated at 220. Generating training data at 220 may be similar to step 204 as shown in FIG. 2A. Generating training data may include generating one or more sets of data, where each set of data has a value for each input vector identified at 212. In some scenarios, each set of data may have sufficient values to provide a value for the identified input vectors, but the values in the set of training data may not correspond one-for-one to the input vectors. The training data may be generated using various parameters, definitions, or restrictions, on the values of the input vectors, or may be generated based on statistical models or distributions for the values of the input vectors, either individually or in groups. The parameters or statistical models (or other input vector definitions) may be determined or derived from the domain, determined at 216, or from the training data foundation, built at 218. Generating training data at 220 generally includes generating training data objects and training data scenarios, as described in process 230 shown in FIG. 2C. Generally, a fixed number of training data sets (or training data objects and training data scenarios) of the generated training data are generated at a given time, as described herein.

The generated training data is stored at 222. Storing the training data at 222 may be similar to step 206 as shown in FIG. 2A. The training data may be stored in the database created at step 214, which may be the training data database 130 shown in FIG. 1. The training data may alternatively or additionally be stored in a file or other data storage system. In some embodiments, the training data is stored after all the training data has been generated. In other embodiments, the training data is stored as it is generated; generally, this will consume less local memory during generation of the training data. For example, once a set of training data is generated, it may be stored before or while the next set of training data is generated.

The machine-learning algorithm or system is trained at 224. Training the machine-learning system at 224 may be similar to step 208 as shown in FIG. 2A. Training the machine-learning algorithm may include accessing the stored generated training data and feeding it into the machine-learning algorithm, as described herein.

FIG. 2C is a flowchart illustrating a split process 230 for pre-generating training data. Input vectors are identified at 232. Identifying input vectors at 232 may be similar to steps 202 and 212 as shown in FIGS. 2A and 2B. The input vectors may be the input variables of the machine-learning algorithm, as described herein.

Training data objects may be generated at 234. Generating training data objects at 234 may be similar, in part, to steps 204 and 220 as shown in FIGS. 2A and 2B. However, generating the training data objects generally does not include generating full sets of training data (e.g. the training data scenarios or sets of input vectors). For example, a machine-learning algorithm for resource provisioning may take as an input a resource request job, which may include input vectors of a requestor address, multiple resources, and resource availability or locations. Generating training data objects at 234 generally includes generating one or more requestor addresses, one or more resources, and one or more resource locations or availability, with the relevant information (e.g. fields or attributes) for each. However, the actual resource request jobs (e.g. a particular requestor address associated with a particular one or more requested sources) is not yet generated; such jobs may generally be training data scenarios, each of which would be a training data set. In this way, the training data objects are pre-generated before training, but not all the particular input vector sets.

In some embodiments, generating training data objects at 234 may include creating a database, determining a domain, or building a training data foundation, as in steps 214, 216, and 218 shown in FIG. 2B.

Generating training data objects may include generating one or more values for one or more input vectors identified at 232. In some scenarios, each set of data may have sufficient values to provide a value for the identified input vectors, but the values in the set of training data may not correspond one-for-one to the input vectors. The training data objects may be generated using various parameters, definitions, or restrictions, on the values of the input vectors, or may be generated based on statistical models or distributes for the values of the input vectors, either individually or in groups. The parameters or statistical models (or other input vector definitions) may be determined or derived from the domain or from the training data foundation.

The generated training data objects are stored at 236. Storing the training data objects at 236 may be similar to steps 206 and 222 as shown in FIGS. 2A and 2B. The training data objects may be stored in a database, which may be a database created at step 234, which may further be the training data database 130 shown in FIG. 1.

Training the machine-learning system is initiated at 238. Training initiation may include setting the target machine-learning algorithm into a state to receive inputs, process the inputs to generate outputs, then be updated or refined based on the generated output. Once the system training is initiated at 238, the training process may be parallelized at 239.

Training data scenarios are generated at 240. Generally, the training data scenarios are generated based on the training data objects, as generated at 234. Generating training data scenarios may include retrieving one or more training data objects from storage and arranging them as a set of input vectors for the machine learning algorithm. This may further include generating one or more additional input vectors or other input values that are not the previously generated training data objects, or are based on one or more of the previously generated training data objects. Extending the previous resource provisioning example for the training data objects, the training data scenarios generated at 240 may be resource request jobs composed from the previously generated requestor addresses and available resources, and further include the available resource locations. For example, when generating a training data scenario such as for the resource provisioning example, a database storing training data objects for requestors, resources, and locations may be accessed to generate a training resource provisioning job. A requestor (e.g. a previously generated training data object) may be selected in generating in the job (e.g. training data scenario), which may include selecting a row of a requestor table; other input vectors may be similarly selected, such as by obtaining one or more previously generated resources from a resources table and so on. In this way, the training data objects previously generated may be used to generate a training data scenario, which may generally be a complete training data set or complete set of input vectors. Generating the training data scenarios may further include generating the expected outputs for the given training data scenario.

As a given training set or scenario is generated at 240, it is then provided 241 to train the machine-learning system at 242. Training the machine-learning system at 242 may be similar to step 208 and 224 as shown in FIG. 2A and FIG. 2B. Training the machine-learning algorithm may include accessing the stored generated training data and feeding it into the machine-learning algorithm. For example, a training data scenario may reference one or more training data objects stored at 236; such training data objects may have been retrieved as part of generating the training data scenario, or may need to be retrieved to complete the input vectors for training the system. Supplying the generated training data to the machine-learning algorithm may be accomplished by the training system 140 as shown in FIG. 1, which may include receiving the generated training data scenario from 240 or accessing training data objects stored at 236, or both. Generally, training the algorithm includes providing a single set of training data inputs to the machine-learning algorithm (e.g. the training data scenarios generated at 240 based on the previously generated training data objects at 234), running the algorithm with the generated training data inputs, obtaining the results of the algorithm processing the inputs, comparing the results to expected results (e.g. the generated expected results for the given training data set), and updating the algorithm based on the differences between the output and the expected results. This process may be repeated for all generated training data scenarios as part of training the machine-learning algorithm. Training may continue until the differences between the output from the algorithm and the expected results are below a certain threshold, below a threshold for a given number of training cycles, or for a given number of training cycles or episodes (e.g. a given number of training data scenarios may be generated). Once the requisite number of training data scenarios are generated 240 and used to train the system 242, the parallelization is closed at 243.

In another embodiment, the process 230 may be implemented without the parallelization at 239 to 243. In one such scenario, the training data scenarios may be generated iteratively at 240 and used to train the system at 242; more specifically, a training data scenario may be generated at 240, then passed 241 for use in training the system at 242, then this is repeated for a desired number of iterations or episodes. In another scenario, the desired number of training data scenarios may be generated at 240, then the scenarios passed 241 to be used to train the system at 242 (e.g. the steps performed sequentially).

FIG. 2D depicts example tables 250, 260 of a domain and data foundation for generating artificial training data. The tables 250, 260 may be generated during steps 216 and 218 of process 210 as shown in FIG. 2B. Table 250 may provide parameters 253 or functions 255, or both, for input vectors 251. Generally, an input vector 251 may have one or more parameters 253 for generating values for the training data for that input vector. Further, an input vector 251 may have an associated function 255 for generating the training data values. In some cases, a vector may not have any parameters 253, such as for Vector 4. In some cases, a function 255 may relate to another input vector 251, such as Vector 4 being calculated based on Vector 1.

Table 260 may provide a scoring function 263 for an output vector 261. Such functions 263 may be based on the value of the denoted output vector, as generated by the target machine-learning system. The scoring functions 263 may be used to train the target machine learning system, and may further help optimize the output of the machine-learning system.

Tables 250, 260 may be stored in a database, a file, local data structures, or other storage for use in processing during training data generation, as described herein. Further, the vectors 251, 261, the parameters 253 and functions 255, 263, may be input and received through a user interface.

### EXAMPLE 5

### On-the-Fly Training Data Generator System Architecture

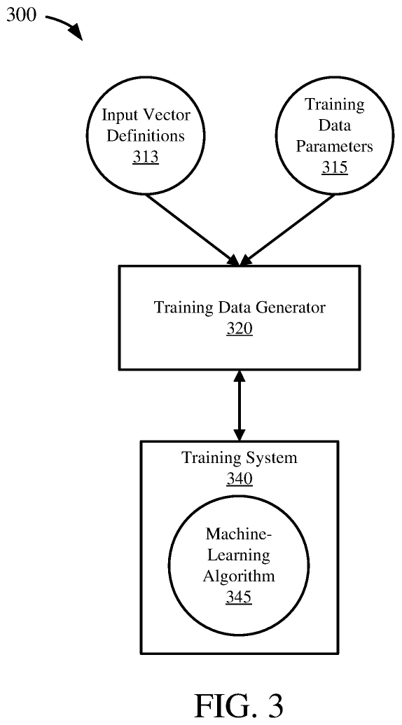

FIG. 3 is a schematic diagram depicting an architecture 300 for an on-the-fly training data generator system. A training data generator 320 may be similar to the training data generator 120 as shown in FIG. 1. The training data generator 320 may generate artificial training data for training a machine-learning algorithm 345, as described herein. The training data generator 320 may receive or obtain input vector definitions 313 or training data parameters 315, or both. The input vector definitions 313 or the training data parameters 315 may be received or obtained by the training data generator 320 as input arguments passed to the training data generator, or may be retrieved from storage, such as a file or database, by the training data generator.

Generally, the input vector definitions 313 may be the definitions of the input variables of the machine-learning algorithm 345 which the training data is intended to train, as described herein.

Generally, the training data parameters 315 may be the parameters for the values or the parameters for generating the values of the input vectors as described in the input vector definitions 313. Such training data parameters 315 may define or restrict the possible values of the input vectors, or may define relationships between the input vectors. The training data parameters 315 may include a data model or statistical model for generating a given input vector. For example, a given input vector may have a parameter set to indicate valid values between 1 and 10, and a generation model set to be random generation of the value. Another example input vector may have a parameter set to indicate valid values that are resource ID numbers in a database, and another parameter is set to indicate that the values are generated based on a statistical distribution of usage of those resources.

The training data generator 320 may access a training system 340; for example, the training data generator may call the training system to perform training of the machine learning algorithm 345 using training data it generated. In other embodiments, the training system 340 may access the training data generator 320; for example, the training system may call the training data generator, requesting training data for use in training the machine learning algorithm 345. In some embodiments, the training data generator 320 and the training system 340 may be fully or partially integrated together. In some embodiments, the training data generator 320 may be composed of several programs, designed to interact or otherwise be compatible with each other, or be composed of several microservices similarly integrated.

The training system 340 can train a machine-learning algorithm 345 using training data as described herein. The training system 340 may be similar to the training system 140 as shown in FIG. 1. Generally, the training system 340 obtains training data from the training data generator 320. The training system 340 feeds the training data to the machine-learning algorithm 345 by providing the training inputs to the algorithm and executing the algorithm. In some cases, the output from the algorithm 345 is compared against the expected or desired output for the given training data set, as obtained from the training data, and the algorithm is then updated based on the differences between the current output and expected output.

### EXAMPLE 6

### Generating Training Data On-the-Fly

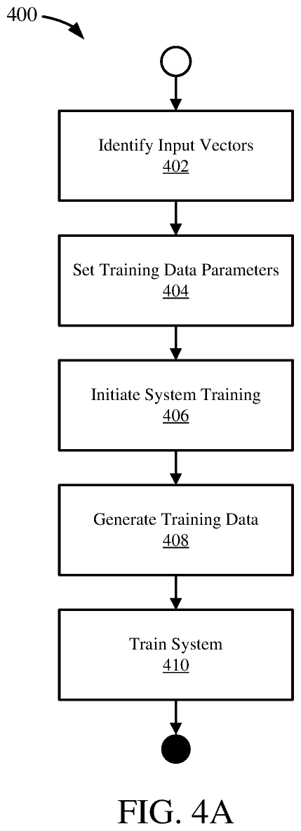

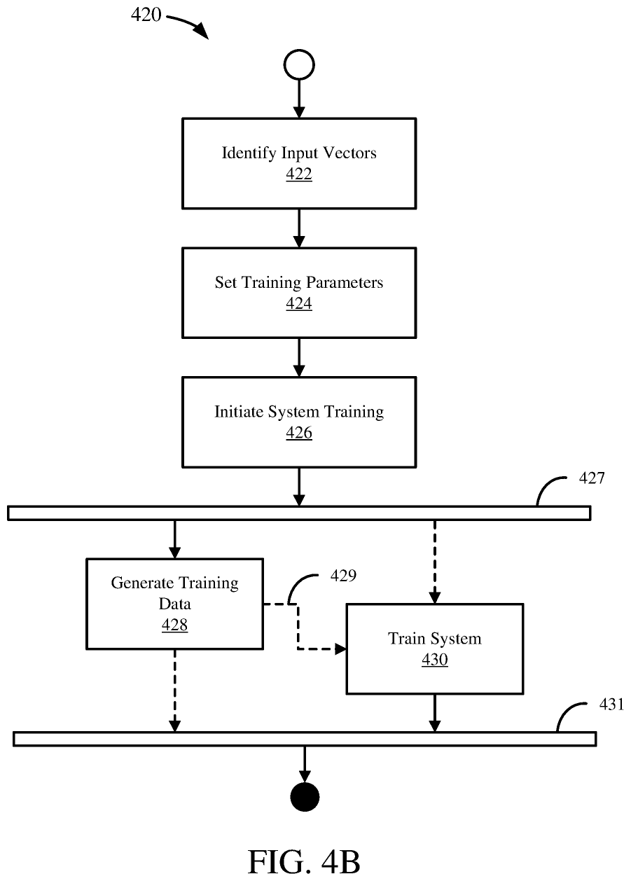

FIG. 4A is a flowchart illustrating a process 400 for generating training data on-the-fly. Input vectors are identified at 402. Identifying input vectors at 402 may be similar to steps 202, 212, and 232 as shown in FIGS. 2A-C. Generally, the input vectors are the input variables of the machine-learning algorithm, as described herein.

Training data parameters may be set at 404. Setting training data parameters may include setting parameters for the identified input vectors. Such parameters may define or restrict the possible values of the input vectors, or may define relationships between the input vectors. Setting the training data parameters may include setting or defining a data model or statistical model for generating a given input vector, as described herein. Such parameters and functions may be similar to those shown in FIG. 2D.

Setting training data parameters may include determining a domain or environment for the generated training data, similar to step 216 as shown in FIG. 2B. This can be considered to be defining the domain for the task to which the trained machine-learning algorithm will be put, and then further translating that definition to the specific input vectors and training data, as described herein.

Setting training data parameters may include building a training data foundation for the generated training data, similar to step 218 as shown in FIG. 2B. The training data foundation may be a knowledge base or statistic foundation for the training data to be generated, as described herein.

Training the machine-learning system is initiated at 406. This may include setting the target machine-learning algorithm into a state to receive inputs, process the inputs to generate outputs, then be updated or refined based on the generated output.

Training data may be generated at 408. Generating training data at 408 may be similar to step 204, 220, 234, and 240 as shown in FIGS. 2A-C. The training data may be generated using various parameters, definitions, or restrictions, on the values of the input vectors, or may be generated based on statistical models or distributes for the values of the input vectors, either individually or in groups, as described herein. The parameters or statistical models (or other input vector definitions) may be obtained, determined, or derived from the training parameters set at 404.

The machine-learning algorithm or system is trained at 410. Training the machine-learning system at 410 may be similar to steps 208, 224, and 242 as shown in FIGS. 2A-C. Generally, training the algorithm includes providing a single set of training data inputs to the machine-learning algorithm, running the algorithm with the generated training data inputs, obtaining the results of the algorithm processing the inputs, analyzing the results (such as comparing the results to expected results), and updating the algorithm based on the results, as described herein. In some embodiments, the algorithm may not be updated, but instead data values may be stored for use in the machine-learning algorithm (e.g. the results, or a portion of the results, may be stored and used later, as, for example, weights).

In one embodiment, the training data may be generated iteratively at 408 and used to train the system at 410 as each set of training data is generated. For example, a training data set of input vectors (and corresponding expected output, if used) may be generated at 408, and immediately passed for use in training the system at 410; then this is repeated for a desired number of iterations or episodes.

FIG. 4B is a flowchart illustrating a parallelized process 420 for generating training data on-the-fly. Input vectors are identified at 422. Identifying input vectors at 422 may be similar to step 402 as shown in FIG. 4A. Generally, the input vectors are the input variables of the machine-learning algorithm which the training data is intended to train, as described herein.

Training data parameters may be set at 424. Setting training data parameters at 424 may be similar to step 404 as shown in FIG. 4A. Setting training data parameters may include setting parameters for the identified input vectors, as described herein.

Setting training data parameters may include determining a domain or environment for the generated training data, similar to step 216 as shown in FIG. 2B. This can be considered to be defining the domain for the task to which the trained machine-learning algorithm will be put, and then further translating that definition to the specific input vectors and training data. Generally, defining the domain or environment should result in a restricted, or well-defined environment for the training data, which ultimately leads to a well-trained or adapted machine-learning algorithm for the particular task to which it is put. This may include defining values or ranges for the various input vectors of the training data, or weights for the various input vectors, or a hierarchy of the input vectors. This may also include adding or removing particular input vectors, or incorporating several input vectors together (such as through a representational model). Data defining the domain may be stored in local variables or data structures, a file, or the database created at 214, or may be used to modify or limit the database.

Setting training data parameters may include building a training data foundation for the generated training data, similar to step 218 as shown in FIG. 2B. The training data foundation may be a knowledge base or statistic foundation for the training data to be generated. This data foundation may be used to ensure that the generated training data is realistic training data, and so avoid noise, or sufficiently unrealistic training data that the data inaccurately trains a machine-learning algorithm when used. The data foundation may be built from varying sources of data, such as the data foundation sources 110 shown in FIG. 1. The training data foundation may be sets of data which may be used to generate the training data, or may be statistical models or distributions of data which may be used in generating the training data. In some scenarios, the statistical models or distributions of data may be derived from one or more data sets being used to build the training data foundation. The degree of realism of the training data may be adjusted based on the use of data foundation sources and the degree or extent to which the training data foundation is built. In some embodiments, the training data foundation may be built based on the determined domain.

Training the machine-learning system is initiated at 426, similar to step 406 as shown in FIG. 4A. This may include setting the target machine-learning algorithm into a state to receive inputs, process the inputs to generate outputs, then be updated or refined based on the generated output. Once the system training is initiated at 426, the training process may be parallelized at 427.

Training data may be generated at 428. Generating training data at 428 may be similar to step 408 as shown in FIG. 4A. Generating training data may include generating one or more sets of data, where each set of data has a value for each input vector identified at 422, as described herein.

As a given training set or scenario is generated at 428, it is then provided 429 to train the machine-learning system at 430. The machine-learning algorithm or system is trained at 430. Training the machine-learning system at 430 may be similar to step 410 as shown in FIG. 4A. Generally, training the algorithm includes providing a single set of training data inputs to the machine-learning algorithm, running the algorithm with the generated training data inputs, obtaining the results of the algorithm processing the inputs, analyzing the results (such as comparing the results to expected results), and updating the algorithm based on the results, as described herein. In other embodiments, the algorithm may not be updated, but results, or a portion of the results, stored for use by the algorithm the next time it is executed. This process may be repeated for all generated training data scenarios as part of training the machine-learning algorithm. Training may continue until the output from the algorithm meets a certain threshold, meets a threshold for a given number of training cycles, or has processed for a given number of training cycles or episodes (e.g. a given number of training data scenarios may be generated). For example, meeting a threshold may include comparing the differences between output values and expected values to the threshold, or determining when output values for similar inputs converge within a threshold variance, or so on. Once the requisite number of training data sets are generated 428 and used to train the system 430, the parallelization is closed at 431.

### EXAMPLE 7

### Training Data Generator Environments

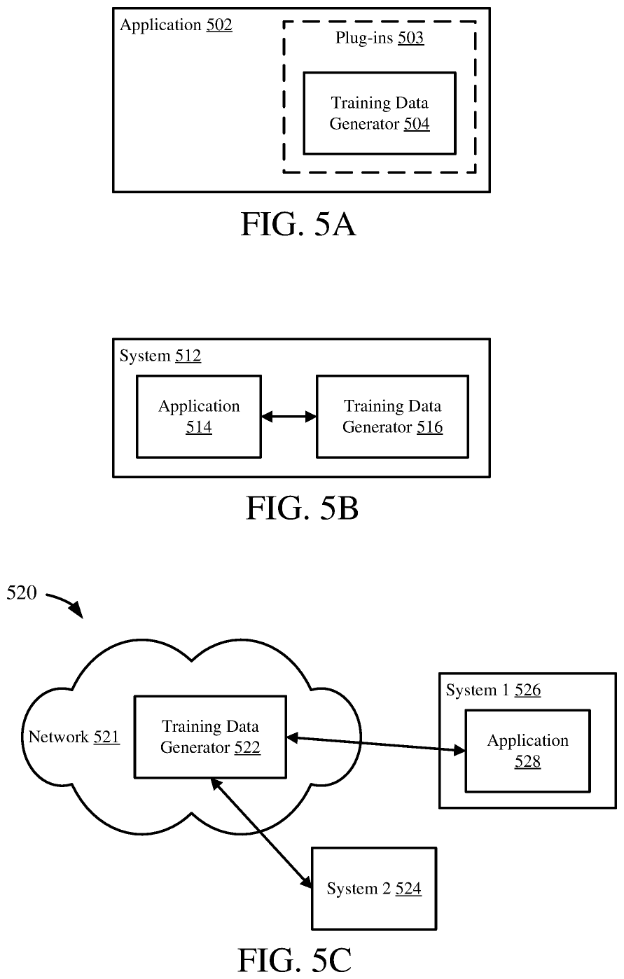

FIG. 5A is a schematic diagram depicting an application environment for a training data generator 504, which may provide artificial training data as described herein. An application 502, such as a software application running in a computing environment, may have one or more plug-ins 503 (or add-ins or other software extensions to programs) that add functionality to, or otherwise enhance, the application. The training data generator 504 may be integrated with the application 502; for example, the training data generator may be integrated as a plug-in. The training data generator 504 may add functionality to the application 502 for generating artificial training data, which may be used for training a machine-learning algorithm. For example, the application 502 may be may be a training or test system for a machine-learning algorithm, and the training data generator may be integrated with the training system to provide or generate artificial training data.

FIG. 5B is a schematic diagram depicting a system environment for a training data generator 516, which may provide artificial training data as described herein. The training data generator 516 may be integrated with a computer system 512. The computer system 512 may include an operating system, or otherwise be a software platform, and the training data generator 516 may be an application or service running in the operating system or platform, or the training data generator may be integrated within the operating system or platform as a service or functionality provided through the operating system or platform. The system 512 may be a server or other networked computer or file system. Additionally or alternatively, the training data generator 516 may communicate with and provide or generate artificial training data, as described herein, to one or more applications 514, such as a training or testing application, in the system 512.

FIG. 5C is a schematic diagram depicting a network environment 520 for a training data generator 522, which may provide artificial training data as described herein. The training data generator 522 may be available on a network 521, or integrated with a system (such as from FIG. 5B) on a network. Such a network 521 may be a cloud network or a local network. The training data generator 522 may be available as a service to other systems on the network 521 or that have access to the network (e.g., may be on-demand software or SaaS). For example, system 2 524 may be part of, or have access to, the network 521, and so can utilize training data generation functionality from the training data generator 522. Additionally, system 1 526, which may be part of or have access to the network 521, may have one or more applications, such as application 528, that may utilize training data generation functionality from the training data generator 522.

In these ways, the training data generator 504, 516, 522 may be integrated into an application, a system, or a network, to provide artificial training data generation as described herein.

### EXAMPLE 8

### Resource Provisioning Example

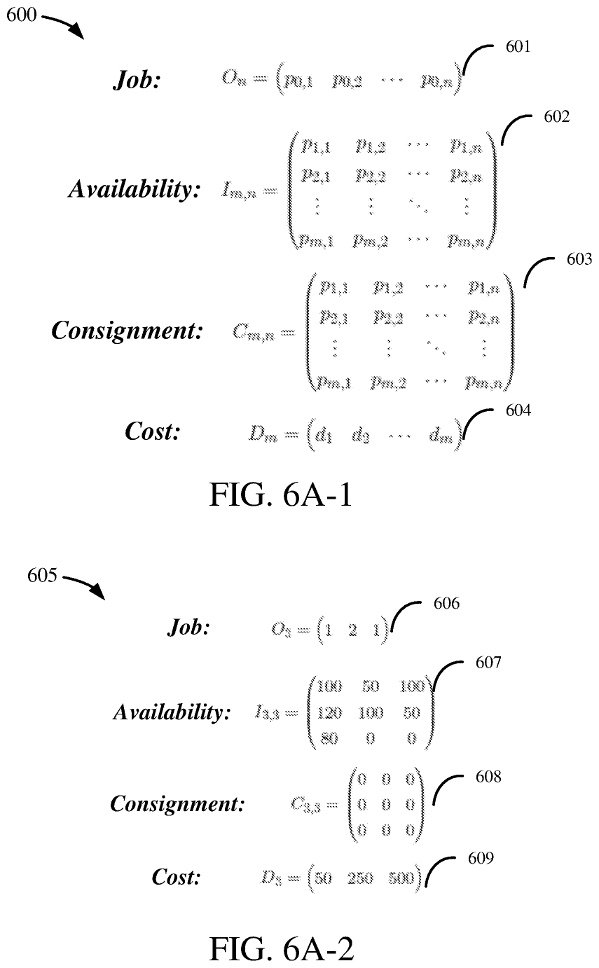

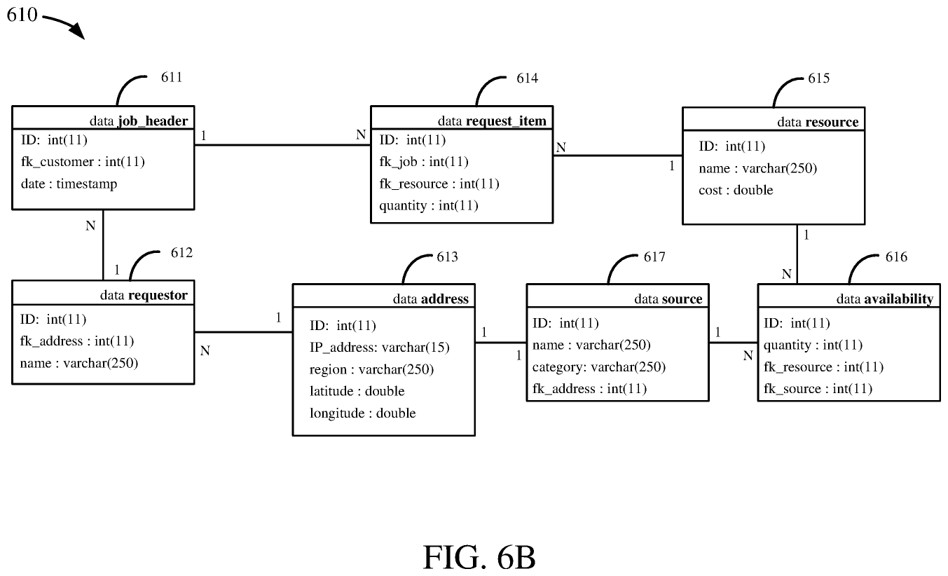

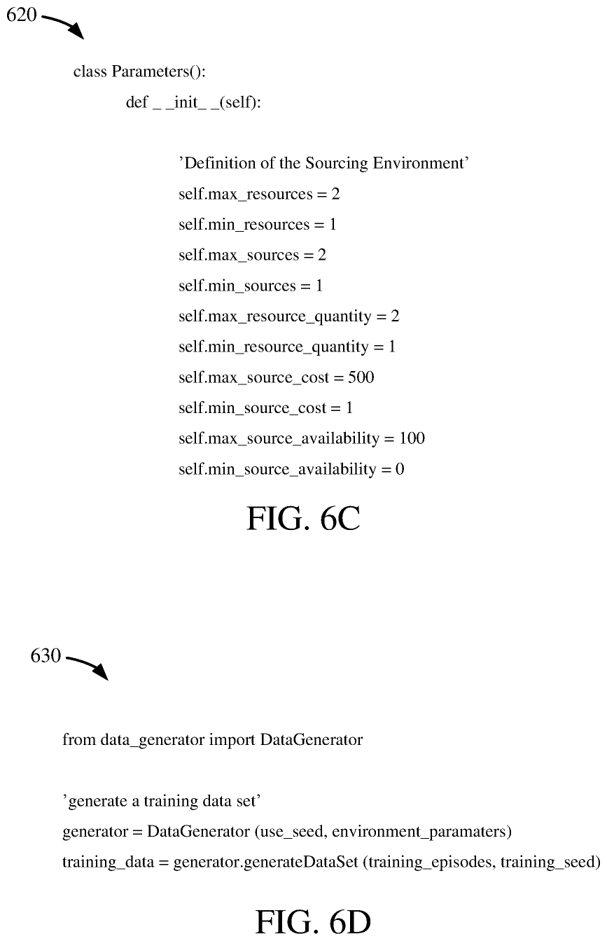

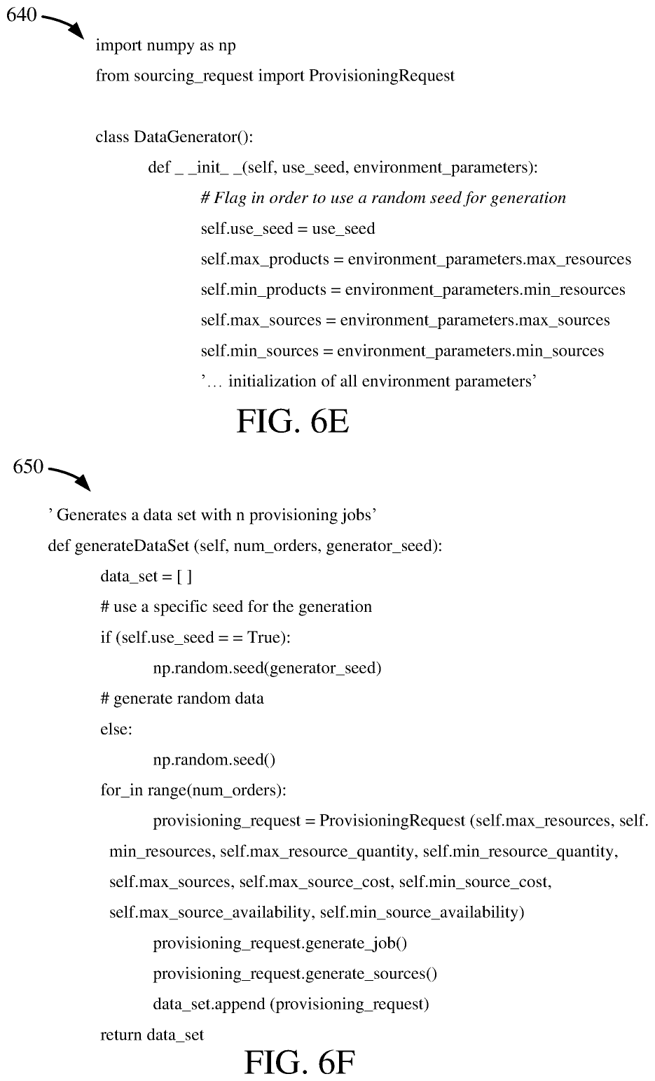

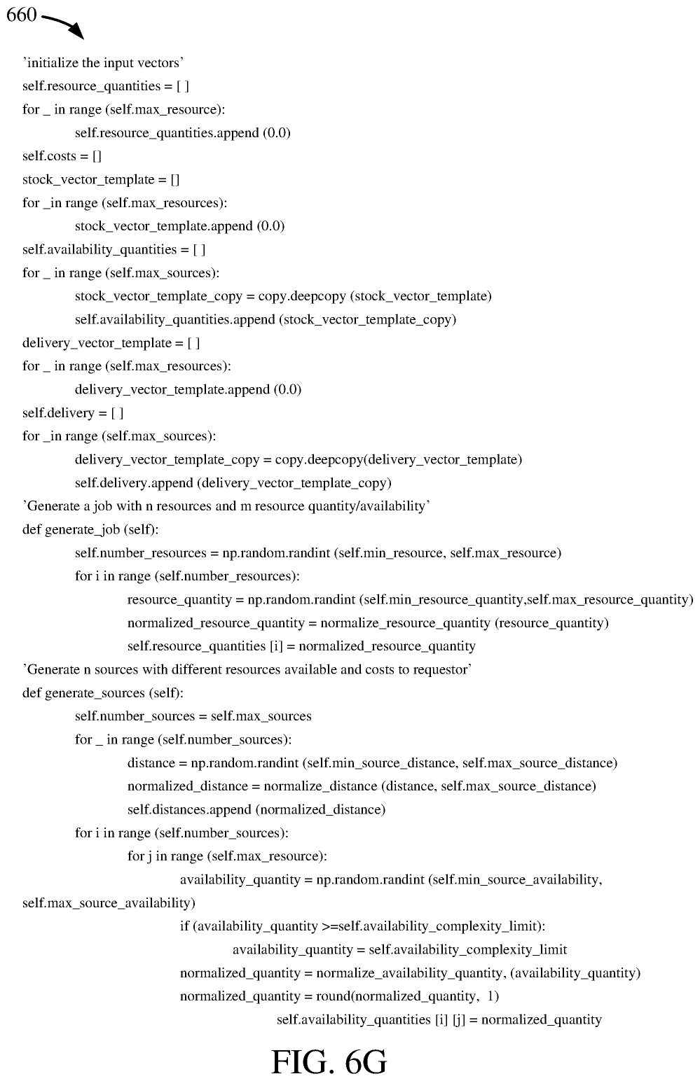

FIG. 6A-1 depicts an example set of input and output vectors 600 for training data to train a machine-learning system for computing resource provisioning. Three input vectors 601, 602, 604 and one output vector 603 may be defined for a system for determining resource provisioning for resource request jobs. A single set of these vectors 600 generally constitutes a single job. The job vector 601 may include quantities for the resources requested, with each location in the vector representing a specific or known resource; in another embodiment, the vector may include identifiers for the one or more resources requested.

The availability vector 602 may include the quantities of each resource available at known sources (e.g. servers or warehouses). The cost vector 604 may include the cost of obtaining the resource from each of the known sources (or, as another example, distance of a purchasing customer to each of the known warehouse sources). The consignment vector 603 may contain the output from the machine-learning system, which may be the quantity of resources provisioned from the known sources. In some embodiments, the output vector 603 may be used to store the expected output from the training process; in other embodiments, the output vector may be used to store the actual output.

FIG. 6A-2 depicts an example set of generated input and output vectors 605 of training data to train a machine-learning system for computing resource provisioning. For this example set of training data, the job vector 606 may have a request quantity of one for the first resource requested, two for the second resource, and one for the third resource. The availability vector 607 may have, for the first source or location, 100 units of the first resource, 50 units of the second resource, and 100 units of the third resource; the next row represents the second source or location and so on. The cost vector 609 may have a cost from the requestor to the first source of 50 (e.g. latency or network hops, or kilometers), 250 to the second source, and 500 to the third source. The output consignment vector 608 may be set to all zero in this example, to represent no expected output (e.g. act as a vector for holding the actual output); in another example, the consignment vector may have other values, such as 1, 2, 1 across the top row, which may represent the quantity of requested resources to be provided from the first source.

FIG. 6B depicts an example entity-relationship (ER) diagram 610 for a database for storing generated artificial training data for a resource provisioning machine-learning algorithm. A database based on the example ER diagram 610 may be created as at step 214 and used as part of process 210, as shown in FIG. 2B and described herein. Such a database may store artificial training data based on the ER diagram 610. Further, such a database may have separate tables for storing separate generated training data objects, which may be data for a given input vector, and for storing training data scenarios, which may be a collection (e.g. a vector) of various training data objects for all input vectors (e.g. one cycle of training/testing).

For example, a database for artificial resource provisioning training data may store, such as in a table, one or more generated jobs 611. Such jobs may be training data scenarios, and each job may be a job input vector (e.g. each row represents one job, which represents a single job vector which may be input to the machine-learning system).

The job 611 may be related to a requestor 612, thus, the database may store information for one or more generated requestors, such as in a table. A requestor may be an input vector, or may relate to an input vector, or both. In general, such a requestor may be a training data object, for use in generating or executing one or more training data scenarios (e.g. jobs). The requestor 612 may each have an address 613, which may be stored in a separate table.

The job 611 may relate to one or more requested items or resources 614, which may be stored in a table. Such items may be part of the job input vector, and so part of a given training data scenario. The requested items 614 may relate to resources (e.g. that are available for allocation or purchase) 615, which may be stored in a table. The resources may relate to the job input vector, and may be generated training data objects from which given training data scenarios are built. The resources 615 may also have an availability 616, which may relate to a source for the resource(s) 617. The source (e.g. server or warehouse) 617 may have an address 613, similar to a requestor 612. The availability 616 may be a training data object that relates to the availability input vector, in conjunction with the source 617 training data objects. Thus, several training data objects may be used to form an input vector for a particular training data scenario (e.g. set of input vectors for a single, complete cycle or episode).

FIG. 6C depicts example code 620 for setting parameters for generating training data. The code 620 may include a special parameter class, a database table, or other data structure, which may in turn include the parameters. The parameters may provide boundaries for the training data generation. The parameters listed and set may be based on the determined domain for the training data. The parameters may provide a minimum or a maximum value for different training data input vectors. Other values of the parameters may be determined based on information from data foundation sources. For example, some parameters may be set based on internally available data, such as a database detailing resource locations or warehouses available, or resource availability or total inventory capacity. In other cases, some parameters may be set based on externally available data, such as network distance or shipping information for maximum shipping distance. In still other cases, some parameters may be set based on historical data, such as identified standard ranges or values for given variables (such as average number of items per job), which may be set to mimic the historical data or exceed or expand on the historical data. The parameter values may be set within the code itself, or may be read in from a file, registry, or database, or may be obtained through a user interface.

FIG. 6D depicts example code 630 for a training data generator, and a call to the training data generator. A training data generator may be implemented as a class, a function, or another processing structure. In some embodiments, a single call to the training data generator may return a single set of training data (i.e. complete data for each input vector to the machine learning algorithm). In other embodiments, a single call to the training data generator may return data for a single training data object (i.e. data for one input vector, such as data or attributes for one warehouse). In still other embodiments, the training data generator may generate multiple sets of training data from a single call. In some embodiments, the training data generator may be a class instantiated as an object before it generates training data. In such cases, the training data generator may be instantiated with the parameters or one or more parameter classes. The training data generator may be called from another program, service, or system, or may be accessed through a user interface.

In some embodiments, the training data generator may use a seed value for generating training data, and may also use an input for the number of training data sets to generate. In cases where a seed value is not used for generating training data, the training data generator generally produces different data sets when it is called, whereas when called with a seed value, the training data generator generally produces similar data sets. A seed value may be used in generating training data to test or ensure that training data is generated differently based on changes to the parameters or other data-defining inputs, such as particular algorithms for generating data for a given input vector.

FIG. 6E depicts example code 640 for defining a training data generator class. FIG. 6F depicts example code 650 for defining a process or method for generating the training data. The method depicted in 650 may be implemented within, or referenced by, the training generator class in 640. Generally, training data consists of multiple training sets of input vectors, such as provisioning requests (e.g. resource request jobs) in the example. A single provisioning request may be a set of training data or a dictionary object, of which a specified number may be generated by the example code 650. In some cases, output training data may be a vector of training data sets, which themselves may be a collection or one or more input vectors. Thus, the collection or vector of training data sets may have one or more sourcing requests, each of which may be one cycle or episode of training/testing (e.g. data for the input vectors to the machine-learning system). For the resource provisioning example, this means a resource request job may be a dictionary object or vector of the job vector, the availability vector, the cost vector, and the consignment vector, which generally is a single set of training data (one training cycle). The number of such dictionary objects or vectors may be created by a given number of calls to the training data generator (one set for one call) or by an input number to the training data generator (one call requesting an input number of training data sets).

FIG. 6G depicts example code 660 for implementing and executing a training data generator for resource provisioning jobs. A sourcing request may be an object of the ProvisioningRequest class, which may initialize the input vectors and generator resource provisioning jobs, as well as the resource sources. The delivery vector in example code 660 may be the consignment vector described herein. The example code 660 illustrates initializing the training data input vectors and generating each of the input vectors (e.g. jobs, sources, availability, costs) based on the training data parameters. In some cases, the consignment vector (e.g. an output vector) may have expected training data generated and stored in it; in other cases, no data may be generated for the consignment vector (e.g. the vector will remain unchanged or may be initialized or set to zero or null).

### EXAMPLE 9

### Additional Training Data Generation Processes

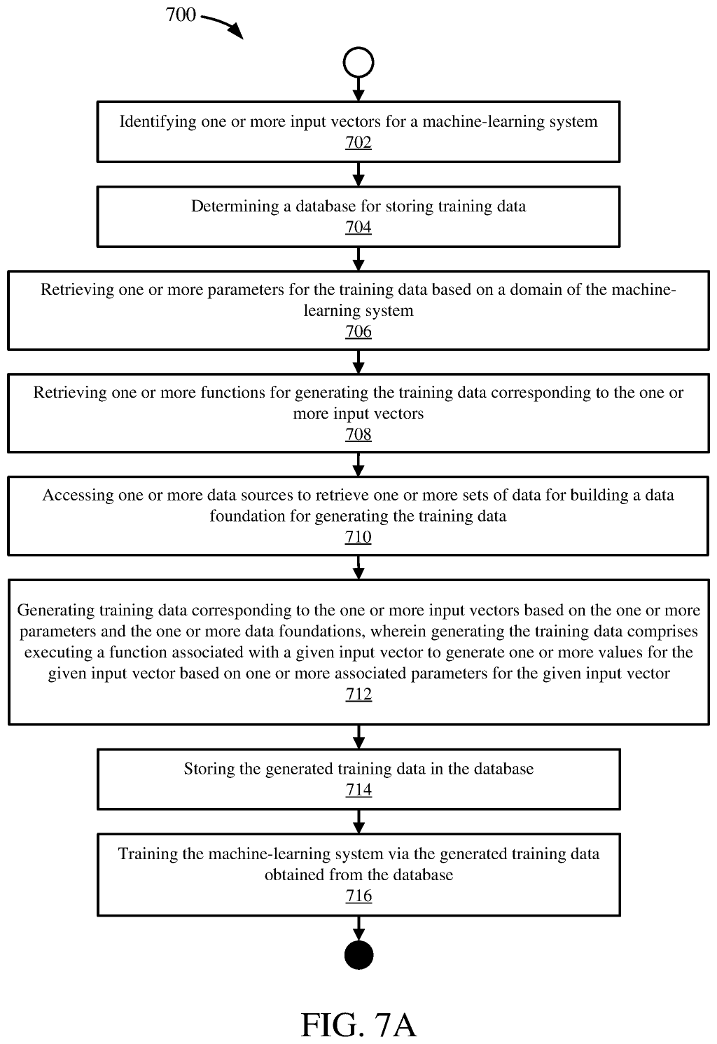

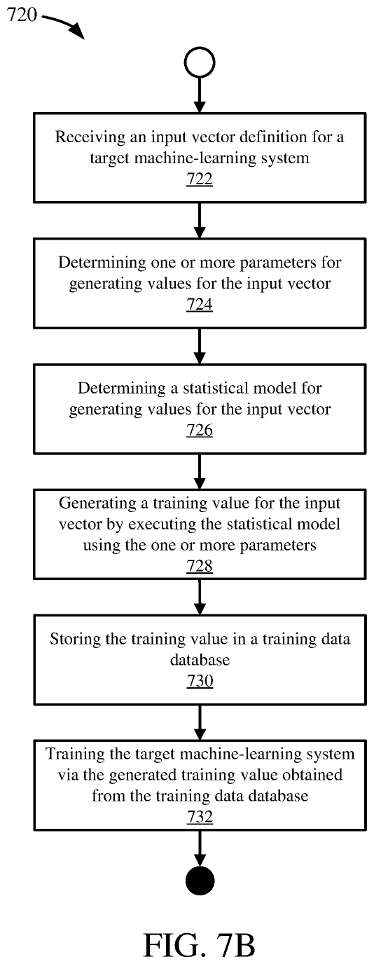

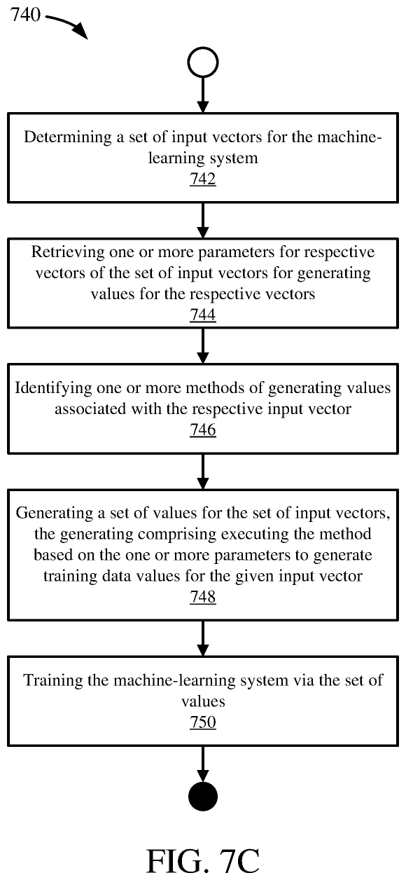

FIG. 7A is a flowchart illustrating a process 700 for machine-learning using artificially generated training data. One or more input vectors for a machine-learning system may be identified at 702. A database for storing training data may be determined at 704. One or more parameters for the training data based on a domain of the machine-learning system may be retrieved at 706. One or more functions for generating the training data corresponding to the one or more input vectors may be retrieved at 708. One or more data sources may be accessed to retrieve one or more sets of data for building a data foundation for generating the training data at 710. Training data corresponding to the one or more input vectors may be generated based on the one or more parameters and the one or more data foundations at 712. Generating the training data may include executing a function associated with a given input vector to generate one or more values for the given input vector based on one or more associated parameters for the given input vector. The generated training data may be stored in the database at 714. The machine-learning system may be trained via the generated training data obtained from the database at 716.

FIG. 7B is a flowchart illustrating a process 720 for generating artificial training data. An input vector definition for a target machine-learning system may be received at 722. One or more parameters for generating values for the input vector may be determined at 724. A statistical model for generating values for the input vector may be determined at 726. A training value for the input vector may be generated by executing the statistical model using the one or more parameters at 728. The training value may be stored in a training data database at 730. The target machine-learning system may be trained via the generated training value obtained from the training data database at 732.

FIG. 7C is a flowchart illustrating a process 740 for training a machine-learning system using artificial training data. A set of input vectors for the machine-learning system may be detected at 742. One or more parameters for respective vectors of the set of input vectors for generating values for the respective vectors may be retrieved at 744. One or more methods of generating values associated with the respective input vector may be identified at 746. A set of values for the set of input vectors may be generated at 748. Generating the one or more values may include executing the method based on the one or more parameters to generate training data values for the given input vector. The machine-learning system may be trained via the set of values at 750.

### EXAMPLE 10

### Computing Systems

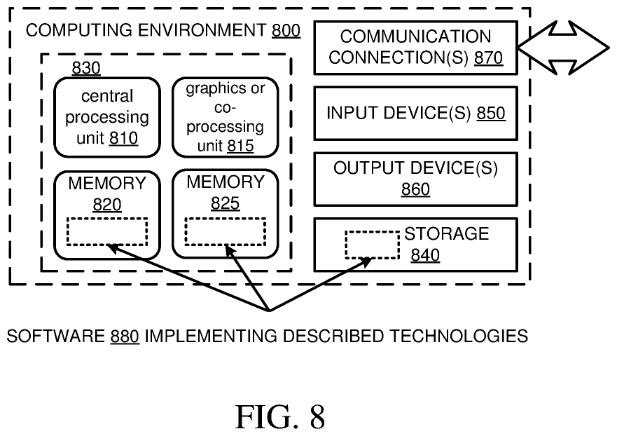

FIG. 8 depicts a generalized example of a suitable computing system 800 in which the described innovations may be implemented. The computing system 800 is not intended to suggest any limitation as to scope of use or functionality of the present disclosure, as the innovations may be implemented in diverse general-purpose or special-purpose computing systems.

With reference to FIG. 8, the computing system 800 includes one or more processing units 810, 815 and memory 820, 825. In FIG. 8, this basic configuration 830 is included within a dashed line. The processing units 810, 815 execute computer-executable instructions, such as for implementing components of the processes of FIGS. 2A-C, 4A-B, 6C-G, and 7A-C, or the systems of FIGS. 1, 3, and 5A-C. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s) 810, 815. The memory 820, 825 stores software 890 implementing one or more innovations described herein, in the form of computer-executable instructions suitable for execution by the processing unit(s) 810, 815. The memory 820, 825, may also store settings or settings characteristics, such as for the vectors and parameters shown in FIGS. 1, 3, and 6A, systems in FIGS. 1, 3, and 5A-C, or the steps of the processes shown in 2A-C, 4A-B, 6C-G, and 7A-C.

A computing system 800 may have additional features. For example, the computing system 800 includes storage 840, one or more input devices 850, one or more output devices 860, and one or more communication connections 880. An interconnection mechanism (not shown) such as a bus, controller, or network interconnects the components of the computing system 800. Typically, operating system software (not shown) provides an operating environment for other software executing in the computing system 800, and coordinates activities of the components of the computing system 800.

The tangible storage 840 may be removable or non-removable, and includes magnetic disks, magnetic tapes or cassettes, CD-ROMs, DVDs, or any other medium which can be used to store information in a non-transitory way and which can be accessed within the computing system 800. The storage 840 stores instructions for the software 890 implementing one or more innovations described herein.

The input device(s) 850 may be a touch input device such as a keyboard, mouse, pen, or trackball, a voice input device, a scanning device, or another device that provides input to the computing system 800. The output device(s) 860 may be a display, printer, speaker, CD-writer, or another device that provides output from the computing system 800.

The communication connection(s) 880 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general purpose program, such as one or more lines of code in a larger or general purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### EXAMPLE 11

### Cloud Computing Environment

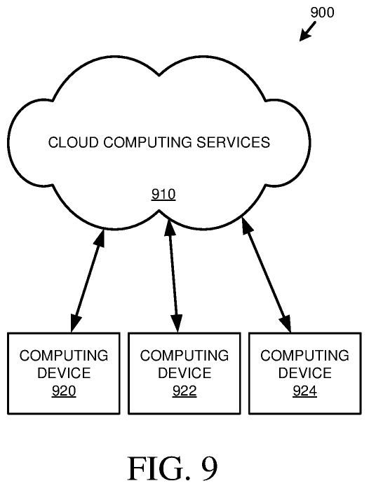

FIG. 9 depicts an example cloud computing environment 900 in which the described technologies can be implemented. The cloud computing environment 900 comprises cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operations (e.g., data processing, data storage, and the like).

### EXAMPLE 12

### Implementations

Although the operations of some of the disclosed methods are described in a particular, sequential order for convenient presentation, it should be understood that this manner of description encompasses rearrangement, unless a particular ordering is required by specific language set forth. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 8, computer-readable storage media include memory 820 and 825, and storage 840. The term computer-readable storage media does not include signals and carrier waves. In addition, the term computer-readable storage media does not include communication connections (e.g., 880).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A system for machine-learning training, the system comprising:
one or more memories;
one or more processing units coupled to the one or more memories; and
one or more computer readable storage media storing instructions that, when loaded into the one or more memories, cause the one or more processing units to perform machine-learning training operations for:
identifying one or more input vectors for a machine-learning system;
determining a database for storing training data;
retrieving one or more parameters for the training data based on a domain of the machine-learning system;
retrieving one or more functions for generating the training data corresponding to the one or more input vectors;
accessing one or more data sources to retrieve one or more sets of data for building a data foundation for generating the training data;
generating training data corresponding to the one or more input vectors based on the one or more parameters and the one or more data foundations, wherein generating the training data comprises executing a function associated with a given input vector to generate one or more values for the given input vector based on one or more associated parameters for the given input vector;
storing the generated training data in the database; and
training the machine-learning system via the generated training data obtained from the database.

2. The system of claim 1, wherein determining the database comprises analyzing the one or more input vectors to determine data definitions for the one or more input vectors and generating a database for storing data for the one or more input vectors based on the determined data definitions.

3. The system of claim 1, wherein identifying one or more input vectors comprises receiving one or more input vector definitions for the one or more input vectors via a user interface.

4. The system of claim 1, wherein retrieving one or more parameters comprises receiving the one or more parameters via a user interface.

5. The system of claim 1, wherein retrieving one or more functions comprises receiving the one or more functions via a user interface.

6. The system of claim 1, wherein the data foundation comprises one or more statistical models for generating values for one or more corresponding input vectors for the generated training data.

7. One or more non-transitory computer-readable storage media storing computer-executable instructions for causing a computing system to perform a method generating artificial training data, the method comprising:
receiving an input vector definition for a target machine-learning system;
determining one or more parameters for generating values for the input vector;
determining a statistical model for generating values for the input vector;
generating a training value for the input vector by executing the statistical model using the one or more parameters;
storing the training value in a training data database; and
training the target machine-learning system via the generated training value obtained from the training data database.

8. The one or more non-transitory computer-readable storage media of claim 7, wherein receiving an input vector definition comprises analyzing the target machine-learning system to identify an input vector argument.

9. The one or more non-transitory computer-readable storage media of claim 7, wherein determining one or more parameters comprises analyzing the input vector definition to determine a type of the input vector.

10. The one or more non-transitory computer-readable storage media of claim 7, further comprising:
associating a scoring function with the generated training value; and
training the target machine-learning system further comprises executing the associated scoring function with output from the machine-learning system when executed with the training data value.

11. The one or more non-transitory computer-readable storage media of claim 10, wherein the training further comprises updating the machine-learning system based on results of the executed scoring function.

12. The one or more non-transitory computer-readable storage media of claim 7, wherein generating the training value further comprises generating an expected output value for the generated training value; and
wherein storing the training value includes storing the expected output value in the training data database.

13. The one or more non-transitory computer-readable storage media of claim 12, wherein training the target machine-learning system further comprises comparing the expected output value against an output value from the machine-learning system when executed with the training data value, and updating the machine-learning system based on the difference between the output value and the expected output value.

14. A method for training a machine-learning system via artificial training data, the method comprising:
determining a set of input vectors for the machine-learning system;
retrieving one or more parameters for respective vectors of the set of input vectors for generating values for the respective vectors;
identifying one or more methods of generating values associated with the respective input vector;
generating a set of values for the set of input vectors, the generating comprising executing the method based on the one or more parameters to generate training data values for the given input vector; and
training the machine-learning system via the set of values.

15. The method of claim 14, wherein the generating the set of values and training the machine-learning system is repeated for a given number of cycles.

16. The method of claim 14, further comprising:
in response to training the machine-learning system, evaluating the machine-learning system; and,
based on the results of the evaluation of the machine-learning system, generating additional one or more sets of values and iteratively training the machine-learning system with the additional one or more sets of values.

17. The method of claim 14, wherein the values of the set of values are generated randomly across a range of possible values.

18. The method of claim 14, wherein the values of the set of values are generated evenly across a range of possible values.

19. The method of claim 14, wherein the training further comprises:
executing a scoring function based on output of the machine-learning system; and,
updating the machine-learning system based on results of the scoring function.

20. The method of clam 14, wherein the generating the set of values and the training the machine-learning system are performed in separate threads.
